(19) United States
(12) Patent Application Publication
(10) Pub. No.: US 2006/0092907 A1
(43) Pub. Date: May 4, 2006

(54) Communication method

(76) Inventors: Isao Shimokawa, Kokubunji (JP); Shunzo Yamashita, Musashino (JP)

Correspondence Address: REED SMITH LLP, Suite 1400, 3110 Fairview Park Drive, Falls Church, VA, 22042, US

(21) Appl. No.: 11/072,363

(22) Filed: Mar. 7, 2005

(30) Foreign Application Priority Data
Oct. 29, 2004 (JP) JP2004-315007

(51) Int. Cl. H04B 7/212; H04Q 7/24

(52) U.S. Cl. 370/347

(57) ABSTRACT

A radio communication system suitable for a sensor net system is provided. In a TDMA method, one slot is divided into four periods. Even when a majority of sensor nodes simultaneously perform access, they can settle in a steady state in high speed corresponding to the transition response of the system. Even when sleep time intervals of the sensor nodes are changed according to the priority thereof and the transmission intervals of the sensor nodes are not constant, the TDMA method control can be performed. Moreover, even when the transmission intervals of the sensor nodes are not constant, the original system performance is not deteriorated.

### CROSS-REFERENCE TO RELATED APPLICATION

The present application claims priority from Japanese Patent Application JP 2004-315007 filed on Oct. 29, 2004, the content of which is hereby incorporated by reference into this application.

### TECHNICAL FIELD OF THE INVENTION

The present invention relates to a radio communication system such as a sensor net for controlling and processing large volume information traffic.

### BACKGROUND OF THE INVENTION

At present, radio congestion controlling methods in communication systems include mainly three methods, i.e., TDMA, FDMA, and CDMA.

In the TDMA method, slots for dividing one frequency at predetermined time intervals are provided. Each of a plurality of sensor nodes can transmit packets through the slots of its own assigned from a base station, and each sensor node can use the entire band width during the assigned time period. The TDMA method requires highly accurate time synchronization, and the sensor nodes receive periodical signals transmitted from the base station so as to solve this problem. Furthermore, between the slots provided is guard time for avoiding packet collision due to, for example, the differentials of the distance between the sensor nodes and the base station, and erroneous variations in transmission timing.

In the TDMA method, unlike the FDMA method, it is not required to assign a frequency to each sensor node, and, unlike the CDMA method, spectrum spreading is not performed. Therefore, it is an effective method in terms of frequency utilization efficiency. Moreover, compared with the FDMA method, the required radio frequency stability is mitigated, the number of transmitters of the base station is reduced, transmission capacity is increased, and the method can flexibly correspond to different transmission speeds by use of multi-slots, or by making the slot length variable. Currently, in accordance with the improvement of synchronization techniques, the TDMA method is widely used in the fields of digital automobile phone, cellular phone, PHS, and satellite communication.

As an conventional example, an example in which the TDMA method is applied to a satellite communication system is provided (for example, see Japanese Patent Application Laid-Open No. 6-45973). In this satellite communication system, in order to improve the utilizing efficiency of a satellite connection, dedicated slots are provided in the slots of the TDMA method, so as to transmit and receive various control signals.

Recently, attracting attentions is a sensor net system for forming an information infrastructure system by building an information network system in which sensor nodes having sensor functions are disposed indoors and outdoors, and the sensor nodes, base stations, the Internet, etc. are united. The sensor nodes used in the sensor net system are communicating with the base stations by means of radio. Each of the sensor nodes used in the sensor net alternately performs two operations at a predetermined intervals, i.e., the operation of a sleep state in which the power of the elements except that a timer circuit (e.g., RTC) is in an OFF state, and the operation of an active state in which the power of all circuits is in an ON state and communication with the base station is performed.

### SUMMARY OF THE INVENTION

The present inventors recognized that, when the TDMA method is applied to a sensor net system having sensor nodes for performing such operations, the following points should be taken into consideration.

Firstly, when the sleep time intervals of the sensor nodes are suddenly changed according to the information obtained by sensing performed by the sensor nodes, the base station has to reassign slots to each of the sensor nodes. In order to perform this operation, each of the sensor nodes has to be in the active state, thereby placing load on the system. Therefore, when the TDMA method is used in an application in which the sleep time intervals of each of sensor nodes are intensely changed, the system performance is significantly deteriorated.

Secondly, when a plurality of sensor nodes simultaneously accesses the base station at initial access of the TDMA method, load is concentrated on the base station, and sometimes it takes time until the system is stabilized. Examples of the application of the sensor net having such problems include a hazard detection system. In the hazard detection system, when a hazard such as fire is to be detected, a great amount of sensor information is required. Therefore, when a hazard occurs, the sleep time intervals of the sensor nodes have to be changed at once, so as to transmit a great amount of sensor information to the base station.

In the satellite communication system mentioned as a conventional example, dedicated slots are provided in the TDMA slots. However, the dedicated slots are provided for the lines for control signals, and data lines are not taken into consideration. Moreover, there is no consideration for the case in which the time intervals at which the sensor nodes access the base station are changed, and the case in which a great number of sensor nodes simultaneously performs initial access with respect to the base station. Therefore, it is difficult to apply the technique mentioned as a conventional example to a system in which change in the traffic of data lines is intensive, such as an application of the sensor net.

An object of the present invention is to solve the problems in the case in which a conventional TDMA method is applied to a sensor net system, and to provide a radio communication system suitable for handling an application in which sleep time intervals of sensor nodes are intensely changed and a great amount of information processing is required.

In a radio communication system according to the present invention, a slot of the TDMA method is divided into four time periods, i.e., a beacon period, an initial access period, an emergency period, and a normal period. The beacon period is used as a time period in which each sensor node receives periodical signals from a base station, the initial access period is used as a time period in which each sensor node performs initial access, the emergency period is used as a time period in which the sensor node of which sleep time interval has been changed performs communication, and the normal period is used as a time period in which each sensor node normally performs communication.

By providing the emergency period in the slot, even when the sleep time intervals of the sensor node are changed, reassignment of slots to the sensor node is not required, thereby preventing deterioration of the performance of the system.

Furthermore, in the radio communication system of the present invention, when the sleep time intervals of the sensor node are changed, in order to notify the base station of the change, a priority number of the sensor node is transmitted to the base station. According to the received priority number, the base station assigns the sensor node to the above described emergency period. Accordingly, even when the sleep time intervals of the sensor node are changed, the sensor node can perform transmission to the base station without causing collision with another sensor node.

Moreover, in the radio communication system according to the present invention, all base stations transmit beacon packets to the beacon periods by broadcasting, and each of the beacon packets contains frequency information of each of the base stations and a parameter (herein, referred to as a unique word) for performing initial access. Each sensor node compares the unique word transmitted from the base station with an ID number unique to each sensor node, and based on the comparison, determines whether the initial access can be performed. Accordingly, even when a large number of sensor nodes performs initial access to the base station, the system can be stabilized in a short period of time without placing load on the base station.

According to the present invention, in a sensor net system using the TDMA method, even when the sleep time intervals of a sensor node are changed, the sensor node and the base station can communicate without placing load on the system.

### BRIEF DESCRIPTIONS OF THE DRAWINGS

FIG. 1 is a schematic diagram of a radio communication system of the present invention;

FIG. 2 is a hardware configuration of a sensor node;

FIG. 3 is a hardware configuration of a base station;

FIG. 4 is a format of TDMA employed in the present invention;

FIG. 5 is a flow chart of the operations of the base station;

FIG. 6 is a flow chart of the operations of the sensor node in an initial access mode;

FIG. 7 is a flow chart of the operations of the sensor node in a normal access mode;

FIG. 8 is a packet structure of a data packet;

FIG. 9 is a packet structure of a beacon packet;

FIG. 10 is a packet structure of an ACK packet;

FIG. 11 is a conceptual diagram of a case in which the sensor node performs initial access to the base station;

FIG. 12 is a conceptual diagram of a case in which assignment is performed in the order of slot numbers;

FIG. 13 is a conceptual diagram of a case in which transition from normal periods to emergency periods is made;

FIG. 14 is a conceptual diagram of a case in which assignment is performed randomly;

FIG. 15 is a conceptual diagram in which transition from normal periods to emergency periods are randomly made; and

FIG. 16 is a conceptual diagram showing differences between a case in which arrangement is regularly performed and a case in which disposition is irregularly performed.

### DESCRIPTIONS OF THE PREFFERED EMBODIMENTS

### First Embodiment

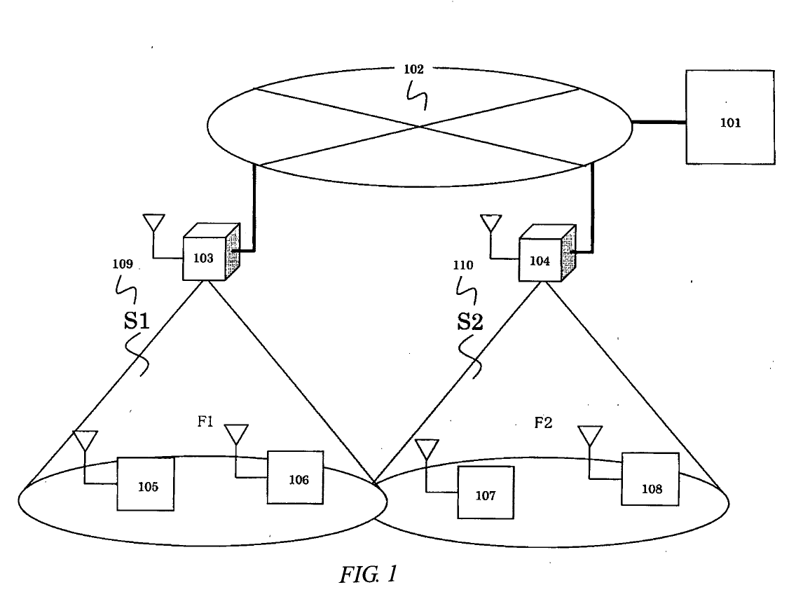

A first embodiment of a radio communication system according to the present invention will be described. In FIG. 1, a schematic diagram of the communication system of the present embodiment is shown. The present system comprises a management server (101) for performing overall control of the entire system, Internet (102), base stations (103 and 104), and sensor nodes (105, 106, 107, and 108). F1 and F2 described in the diagram denote frequencies used in data channels of the base stations, and S1 and S2 (109 and 110) denote service areas in which the base stations can manage the sensor nodes.

At predetermined intervals, each of the sensor nodes separately uses two operations, i.e., that in a sleep state in which, in hardware, power of the members except that of a timer circuit (e.g., RTC) is caused to be in an OFF-state, and that in an active state in which power of all circuits thereof is caused to be in an ON-state. In the active state of the sensor node, sensing is performed by use of various sensors. The sensor node stores, in a packet, the information obtained through sensing, and transmits the packet to the base station by means of a radio wave.

When the base station receives, without fault, the packet which has been transmitted from the sensor node, the base station transmits a command Ack packet so as to instruct the sensor node about sleep time intervals. When the sensor node receives, without fault, the command Ack packet, the sensor node transmits an Ack packet for notifying the base station of completion of reception. Then, through cables, the base station notifies the management server of the sensor information that has been notified by the sensor node through a radio wave. The management server performs overall control of the base stations, stores the sensor data, which has been transmitted from each of the base stations, in a database, and provides information to users via the Internet.

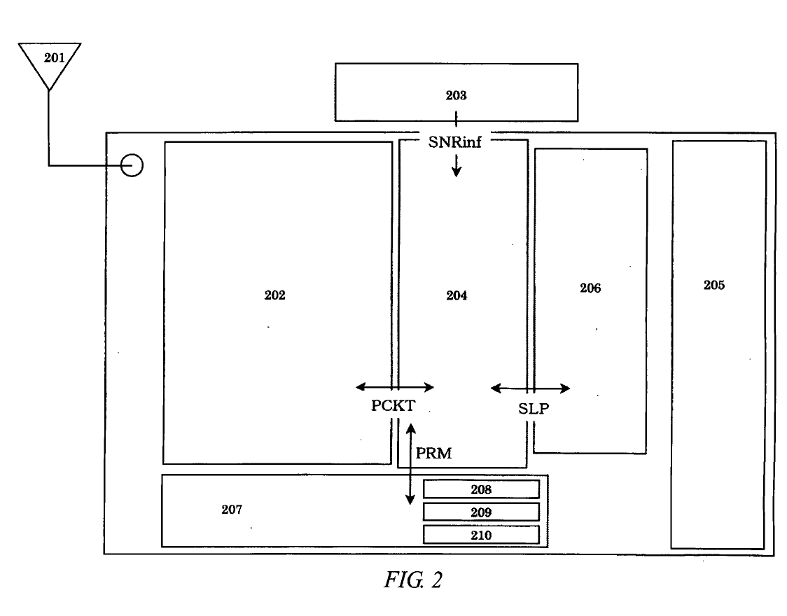

In FIG. 2, a hardware configuration of the sensor node is shown. The sensor node comprises an antenna (201), an RF unit (202), a sensor (203), a CPU (204), a battery (205), an RTC (Real Time Clock) (206), and a memory (207). The sensor node performs transmission and reception of radio waves via the antenna. The RF unit performs generation of the radio waves for transmitting data, and demodulation of transmitted radio waves.

In the active state, the CPU deploys, in a RAM of the sensor node, a control program which is stored in a ROM in the sensor node, and executes the control program. When the sensor node is to transmit a packet to the base station, the CPU executing the control program instructs the sensor to transmit sensor information (SNRinf) to the CPU. The CPU which has received the sensor information stores it in a packet (PCKT), and then, instructs the RF unit to transmit the packet.

When the sensor node receives a packet from the base station, the RF unit demodulates the packet transmitted from the base station, and the CPU receives the demodulated packet, thereby obtaining various parameters such as sleep time intervals of the CPU. The CPU outputs the obtained parameters (PRM) to the memory, and outputs an instruction signal of the sleep time intervals (SLP) to the RTC so as to cause the RTC to output an activation signal after a predetermined period of time according to the sleep time intervals. The RTC is always active and manages time.

The sensor performs sensing of, for example, a temperature, humidity, or mass, when the sensor node is in the active state. The sensor may be internally provided in or externally attached to the sensor node, or alternatively, may be provided in both inside and outside of the node.

In the active state, the sensor node is provided with two operation modes, i.e., an initial access mode and a normal access mode. The operation modes are autonomically determined by the sensor node by use of an initial access flag (208) stored in the memory. A unique node ID (209) possessed by each sensor node and a control program (210) for controlling various operations are also stored in the memory.

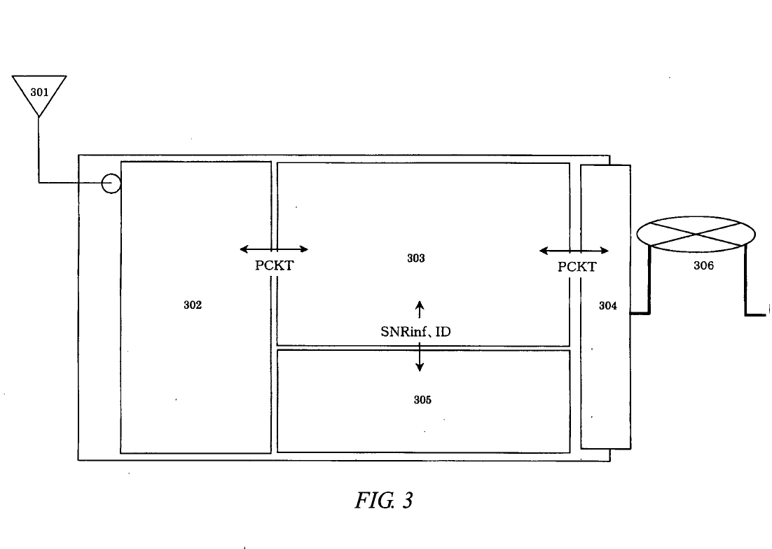

In FIG. 3, the hardware configuration of the base station is shown. The base station comprises an antenna (301), an RF unit (302), a CPU (303), a Network IF (network interface) (304), and a DB (database) (305). The base station communicates with the management server through the Network IF and via a LAN (306) (or the Internet) by use of cables. The antenna of the base station performs transmission and reception of the radio waves transmitted from the sensor nodes. The RF unit of the base station demodulates the radio waves transmitted from the sensor nodes, and also generates radio waves for transmitting data. The CPU sends the packets (PCKTs) transmitted from the sensor nodes and the packets to be transmitted to the sensor nodes to the RF unit, and also transmits and receives packets to or from the Network IF. The DB receives, from the CPU, sensor information (SNRinf) and unique IDs (IDs) of the sensor nodes which have been transmitted from the sensor nodes, and stores them.

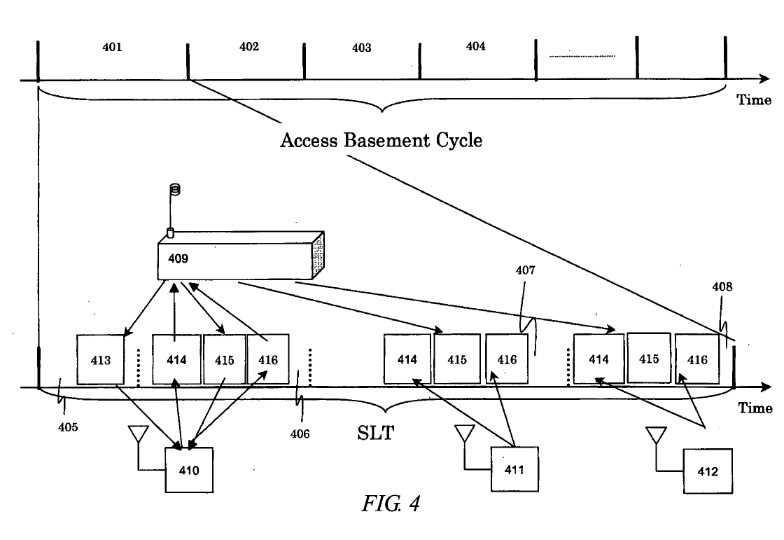

In FIG. 4, a format of TDMA employed in the present invention is shown. In the TDMA according to the present invention, time division is performed based on an access reference period, and the access reference period is divided into, for example, slots (401, 402, 403, and 404). One slot (SLT) is separated into four time periods. There provided are a beacon period (405) as a first time period, an initial access period (406) as a second time period, an emergency period (407) as a third time period, and a normal period (408) as a fourth time period. In each of the periods, each of sensor nodes (410, 411, and 412) performs basic operations, i.e., transmission of a data packet (414) to a base station (409), reception of a command Ack packet (415) transmitted from the base station, and transmission of an Ack packet (416) to the base station.

In the beacon period, each base station transmits a beacon packet (413) in each slot to a sensor node by broadcasting. Broadcasting means transmission by use of a known standardized frequency as a radio wave. Each of the sensor nodes receives the beacon packets at predetermined periods; after obtaining frequency information contained in the beacon packet, sets the frequency thereof to the obtained frequency; and transmits a data packet to the base station; thereby performing initial access. At this point, the sensor node is in the initial access mode.

When initial access is to be carried out, each of the sensor nodes determines whether the initial access can be carried out, by use of a unique word contained in the beacon packet. In the initial access, firstly, each of the sensor nodes performs carrier sensing. The sensor node goes into the sleep mode if another sensor node is in communication at this time, wherein the previously received unique word and the ID of the sensor node of its own are collated so as to estimate and set the sleep time. Again, each of the sensor nodes receives a beacon packet after the sleep time, and carries out initial access. When a sensor node succeeds in initial access by transmitting the data packet (414) to the base station; according to a priority number and by use of the command Ack packet (415), the base station instructs the sensor node to perform time compensation with respect to the slots of TDMA. After receiving the instruction through the command Ack packet, the sensor node performs time compensation such that it can access during the normal period, and becomes active in certain predetermined time intervals. Then, the sensor node transmits the Ack packet so as to notify the base station of the completion of reception of the command Ack packet.

After performing the initial access, each of the sensor nodes makes the transition to the normal access. After making the transition to the normal access mode, each of the sensor nodes stops carrier sensing, and starts communication by using the normal period (408). Herein, the base station is buffering the data of the registered ID of each of the sensor nodes with respect to the two periods, i.e., the emergency period and the normal period. When the base station assigns the sensor nodes to the normal periods, the base station assigns them to the normal periods in the numerical order of the slots.

Next, the operation in the case in which the sleep time intervals of the sensor node is changed will be described. When the sleep time intervals of the sensor node is changed, the sensor node notifies the base station by use of a priority number. The base station detects the change of the priority number, and assigns the sensor node to the emergency periods (409) in the numerical order of the slots.

The priority number changes under certain conditions. For example, a threshold value of a sensor temperature is set, and when the sensor determines that the priority of the sensor information to be transmitted to the base station is increased equal to or more than the threshold value, the priority number becomes higher. The priority number is stored in the data packet which is to be transmitted by the sensor node, and is informed to the base station. The base station already has the data of the sleep time intervals corresponding to each priority number, and assigns the sensor node to the emergency periods according to the notified priority number. The setting of the priority number according to temperatures is merely an example, and it is not specified only by this condition.

In the present invention, a normal period and an emergency period are always provided in a slot as described above. Therefore, even when the sleep time intervals of a sensor node is suddenly changed in a steady state of TDMA, communication of other sensor nodes is not impeded, and reassignment of the slots of TDMA is not required, thereby generating no delay time, which is advantageous.

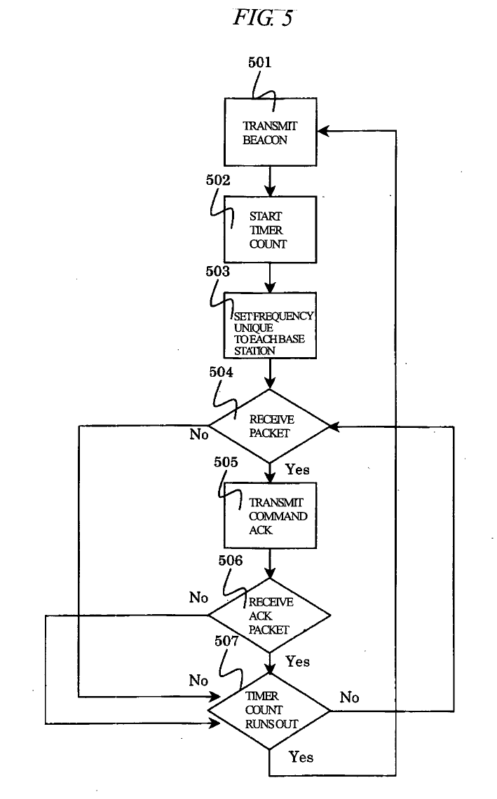

In the present embodiment, although a slot is divided into four periods, the number is not limited thereto. As long as the period that can transmit by a sensor node in an emergency is provided in a slot, the division number of the slot can be appropriately changed in accordance with the use of the system. Next, the operations between the base station and the sensor node will be described with reference to the flow charts shown in FIG. 5 to FIG. 7.

In FIG. 5, a flow chart of the operations of the base station is shown. The base station transmits the beacon packets to the sensor node at predetermined periods (501). Then, the base station starts timer count (502). Then, the base station sets a frequency that is unique to each base station (503), and starts packet reception (504). Then, when the base station receives a packet which has been transmitted from the sensor node, the base station instruct the sensor node to perform compensation in terms of time with respect to the slots of TDMA, according to the priority number transmitted from the sensor node and by use of command Ack (505). The base station receives the Ack packet which has been transmitted from the sensor node which has received the command Ack packet (506), then, when the timer count becomes specified value time and the timer count runs out (507), transmits the beacon again.

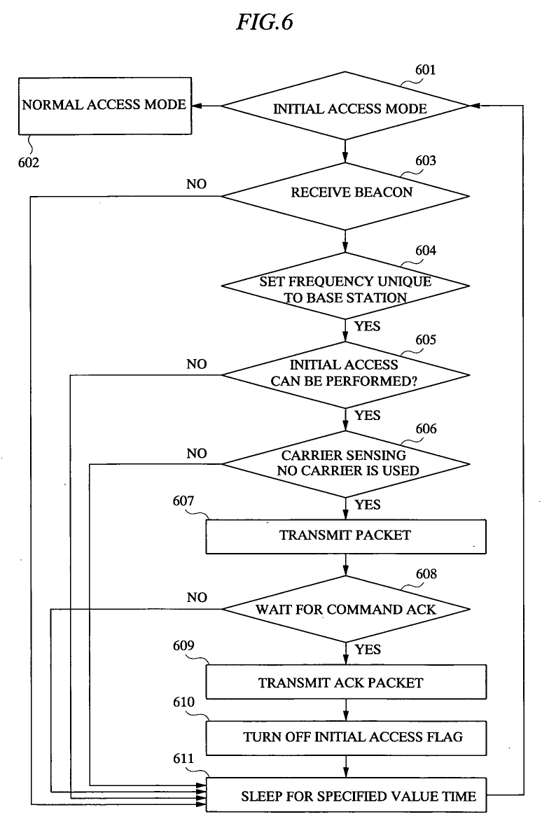

In FIG. 6, a flow chart of the sensor node in the initial access mode is shown. Firstly, the sensor node checks whether the initial access mode should be performed (601). If the flag of the initial access mode is on, the sensor node makes the transition to the initial access mode, and if the flag is off, the sensor node makes the transition to the normal access mode (602). When the initial access mode is to be performed, the beacon packet, which is periodically transmitted from the base station, is initially received (603). Then, the sensor node sets a data channel frequency which is contained in the beacon signal and unique to each base station (604). Then, whether the initial access can be performed or not is determined according to the unique word contained in the beacon of the base station (605).

Regarding the rule for determining that the initial access can be performed, the following cases are conceivable. The conceivable cases include, for example, a case in which when the node ID is divided by the unique word and the quotient is an odd number, a case in which the node ID is divided by the unique word and the quotient is an even number, a case in which the node ID is divided by the unique word and the remainder is an odd number, a case in which the node ID is divided by the unique word and the remainder is an even number, a case in which the unique word is an even number, a case in which the unique word is an odd number, a case in which the node ID is divided by the unique word and the quotient is identical to the slot number, and a case in which the node ID is divided by the unique word and the remainder is 0.

If communication can be performed, carrier sensing is performed in the initial access period so as to determine the communication state of other sensor nodes (606), and when no other sensor node is in communication, the sensor node transmits a packet (607). Then, the command Ack packet transmitted from the base station is received (608). When the command Ack packet is not received, the sensor node sleeps for the specified value time according to the information of the unique word received through the beacon packet (611). Then, the sensor node checks again whether the initial access mode should be performed, and starts receiving the beacon packet. When the command Ack is received, the sensor node transmits the Ack packet responding to the command Ack (609). Then, the initial access flag is turned to be OFF (610), and the sensor node goes into sleep for the specified value time (611). As described above, in the initial access mode, the sensor node determines whether the initial access can be performed or not according to the transmitted unique word and the ID of its own and based on a predetermined rule. Therefore, even when a large number of sensor nodes performs initial access to the base station, the system can be stabilized in a short period of time without placing load on the base station.

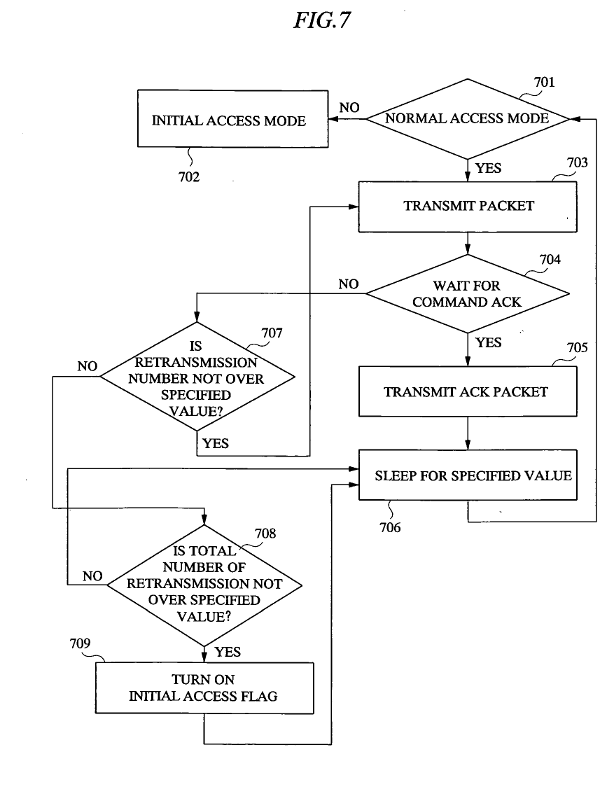

In FIG. 7, the flow chart of the sensor node in the normal access mode is shown. After being activated, the sensor node checks whether the transition to the normal access mode is made (701), and, when it is in the normal access mode, the sensor node starts transmitting a packet (703). Then, the sensor node receives the command Ack packet transmitted from the base station (704). When the command Ack packet is not received, the number of retransmission is checked and when the number is equal to or less than a set specified value, the sensor node retransmits the packet (707). When the number of retransmission is more than the set specified value, the total number of the retransmission is further checked, and when it is more than the specified value (708), the initial access flag is turned to be ON (709). Then, the sensor node goes into a sleep state for the set specified value time (706). When the command Ack is received, the sensor node transmits the Ack packet (705), and goes into a sleep state for the specified value time that has been set by receiving the instruction of time compensation from the base station (706).

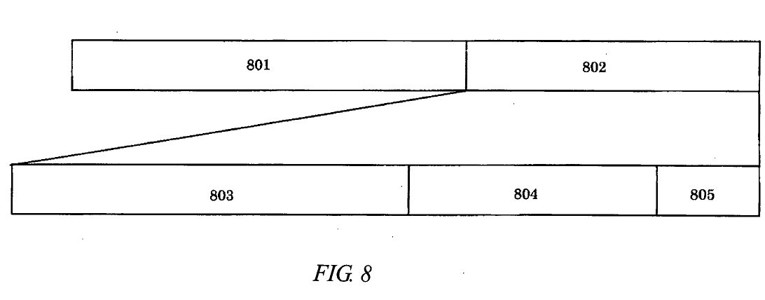

Next, by use of FIG. 8 to FIG. 10, the packet structure of each of the packets transmitted from the sensor node and the base station will be described.

In FIG. 8, the packet structure of the data packet transmitted from the sensor node is shown. The data packet comprises a physical layer header (801) and normal data (802). The normal data comprises a MAC layer header (803), a data portion (804), and an error detection code (805). The physical layer header includes information such as that of signals for achieving synchronization, and the packet length. The MAC layer header includes the sensor node ID and the information for congestion control. The error detection code is the code for detecting the error of the packet. If the code does not match the code derived from the data portion, the packet is assumed to be erroneous. The data of the data packet and the Ack packet has the same structure.

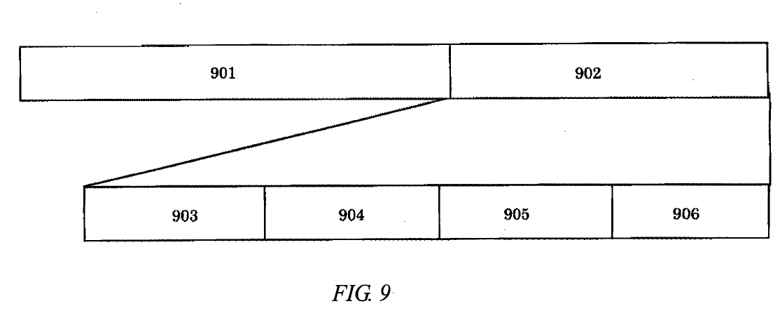

In FIG. 9, the packet format structure of the beacon packet transmitted from the base station is shown. The beacon packet comprises a physical layer header (901) and beacon data (902). The beacon data comprises the information of a MAC layer header (903), a unique word (904), a frequency channel number (905), and an error detection code (906). The physical layer header (901) includes information such as that of signals for achieving synchronization, and the packet length. The MAC layer header (903) includes the sensor node ID and the information for congestion control. The unique word is used when each sensor node performs initial access. Herein, the unique word is defined as a value having certain regularity. For example, it is conceivable to cause the unique word to have the same number as the slot number, i.e., the unique word of the beacon packet in SLOT 1 is 1, and the unique word in SLOT 2 is 2. According to the frequency channel number (905), each sensor node performs setting of the frequency for a data channel that is owned by each base station.

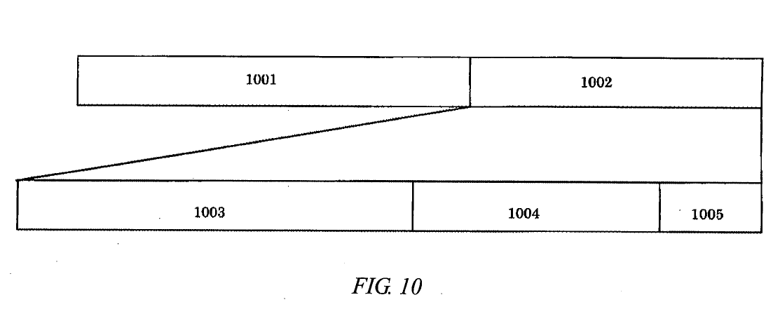

In FIG. 10, the packet format structure of the command Ack packet transmitted from the base station is shown. The command Ack packet comprises a physical layer header (1001) and command data (1002). The command data of the command Ack packet comprises a MAC layer header (1003), compensation time (1004) and an error detection code (1005). The physical layer header includes information of, for example, signals for achieving synchronization and the packet length. The MAC layer header includes the ID of the sensor node and the information for congestion control. According to the compensation time, each sensor node performs compensation of sleep time intervals.

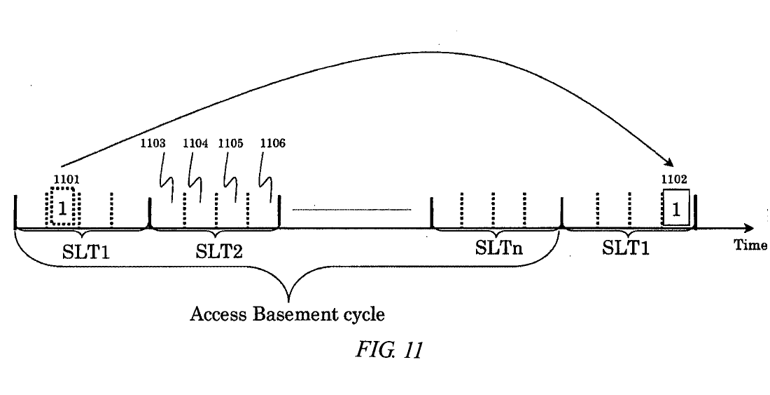

Next, by use of FIG. 11 to FIG. 13, there described the relation between the slots and the packets in the initial access mode, the normal access mode, and when the sensor nodes perform transmission in the emergency periods.

First, in FIG. 11, the relation between the packets transmitted from the sensor node and the periods in the slots in the initial access mode of the sensor node will be described. As described above, each slot is divided into a beacon period (1103), an initial access period (1104), an emergency period (1105), and a normal period (1106). The sensor node transmits a packet (1101) to the initial access period of a slot (SLT1), so as to perform the initial access to the base station. The base station which has received the packet registers the ID, which is unique to the sensor node, in the database. Then, the sensor node which has received the command Ack packet transmitted from the base station performs time compensation, such that subsequent packet can be transmitted to a normal packet period (1102).

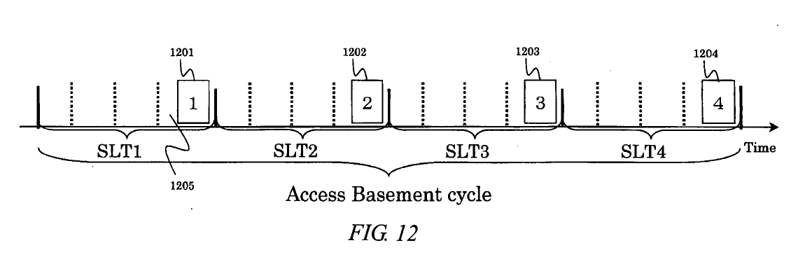

In FIG. 12, the assigning method for the normal periods in the normal access mode of the sensor nodes is shown. Each of the sensor nodes performs the initial access so as to perform registration with respect to the database of the base station. Then, each sensor node is subjected to time compensation with respect to other sensor nodes by use of the command Ack packet. The sensor nodes which have undergone time compensation are regularly arranged in the order of registration in normal periods (1205) each of which is provided in each slot, and the sensor nodes transmit packets (1201, 1202, 1203, and 1204).

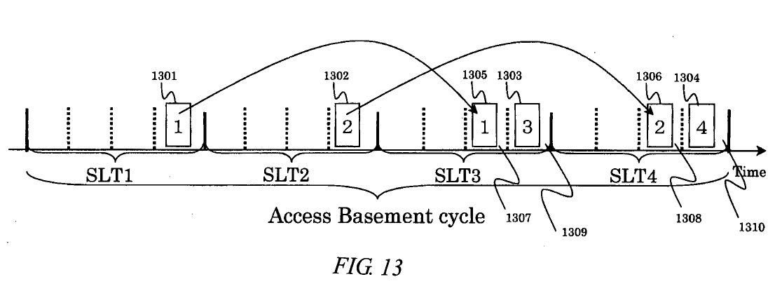

In FIG. 13, the method in the case in which the sensor nodes perform transmission in emergency periods is shown. In this case, the method for assigning packets (1301, 1302, 1303, and 1304), which are transmitted from the sensor nodes, to the normal periods and the emergency periods according to the priority of the sensor nodes will be described. The sensor nodes notifies the base station of the state transition from a steady state, according to the priority numbers. When the sensor nodes have higher priority numbers, the packets of the sensor nodes are assigned to the emergency periods in the order of slot numbers. Herein, for example, a packet (1305) transmitted from a sensor node 1 having a higher priority number is assigned to an emergency period (1307) of a slot 3 (SLT3), and a packet (1306) transmitted from a sensor node 2 is assigned to an emergency period (1308) of a slot 4 (SLT4). Accordingly, the sensor nodes having higher priority numbers can transmit packets without causing collision with packets (1303 and 1304) transmitted from the sensor nodes using normal periods (1309 and 1310).

Described next will be an example of a set of theoretical values of system parameters of a sensor net system in which a TDMA method of the present invention is used. It goes without saying that the parameters can be also applied to a later-described second embodiment.

It is assumed that the data rate is 19.2 [kbps] as the radio specification, FSK (Frequency Shift Keying) is used as a radio communication method, the sleep time interval of the sensor node is 5 minutes, one packet is 240 [bits] and retransmission is not performed, and one base station can control 1,000 units of the sensor nodes.

Since 5 minutes serve as an access reference period, and one base station can control 1,000 units of the sensor nodes, one slot can be defined as 300 [sec]/1,000 [units] that is 300 [ms]. Herein, the time required by one packet is 240 [bits]/19.2 [kbps], therefore the required time is about 12.5 [ms]. It is taken into consideration that the time required by one packet is 12.5 [ms], and one slot 300 [ms] is divided into four periods. Since the beacon period serving as the first period is the period merely for receiving beacon, a guard band is taken into consideration and the beacon period is set to be 20 [ms]. Then, each of the initial access period, the emergency slot period, and the normal slot period is set to be 93 [ms] by equally dividing the remaining 280 [ms]. Therefore, in the above described example, it can be defined that one slot is 300 [ms], the beacon period is 20 [ms], the initial access period is 93 [ms], the emergency period is 93 [ms], and the normal period is 93 [ms].

In conventional TDMA methods, when 5 minutes serve as a reference period and 1,000 units of sensor nodes can be controlled, as well as the proposed method, one slot is 300 [ms] However, since the time required by one packet is 12.5 [ms], the period during which users do not occupy the time is present more than 250 [ms] in one slot. The present embodiment usefully and efficiently uses such periods.

### Second Embodiment

A second embodiment of the present invention will be described. In the first embodiment, there has been described a situation in which the base station assigns the sensor nodes to the normal periods of the slots in the order that the IDs of the sensor nodes are registered in the base station. However, in the second embodiment, there described a situation in which, regardless of the order of registration, the base station randomly assigns the sensor nodes to the normal periods of the slots.

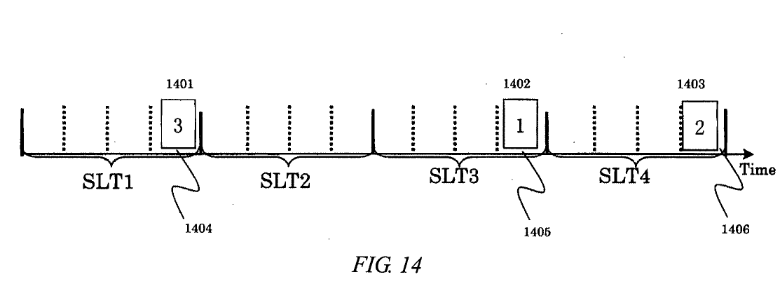

In FIG. 14, there shown a method of a case in which the sensor nodes are randomly assigned to the normal periods. Each of the sensor nodes performs initial access so as to perform registration with respect to the database of the base station. Then, each sensor node is subjected to time compensation with respect to other sensor nodes by use of the command Ack packet. The sensor nodes which have undergone time compensation are randomly assigned to the normal periods, and transmit packets (1401, 1402, and 1403). Herein, for example, a sensor node 3 having an ID number 3 transmits a packet to a normal period (1404) of a slot 1 (SLT1), a sensor node 1 having an ID number 1 transmits a packet to a normal period (1405) of a slot 3 (SLT3), a sensor node 2 having an ID number 2 transmits a packet to a normal period (1406) of a slot 4 (SLT4).

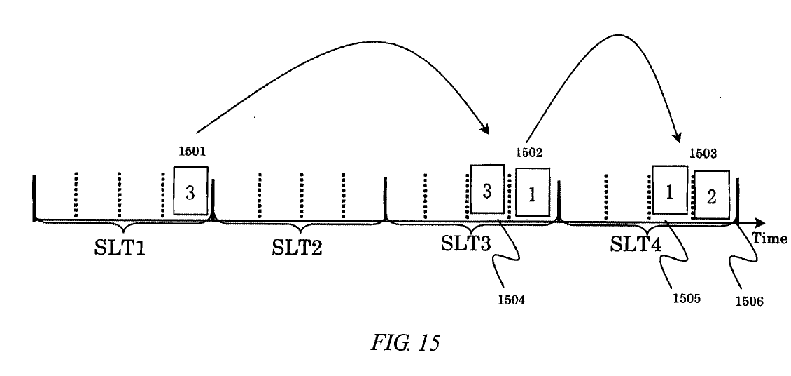

In FIG. 15, there described a method in which, when the transition of a state from the normal period to the emergency period is made in the present embodiment, the normal period and the emergency period are assigned according to the priority of the sensor node. According to the priority number, the sensor nodes notify the base station of the state transition from a steady state. When the priority numbers are high, the sensor nodes are randomly assigned to the emergency periods in the order of the slot number, and the sensor nodes transmit packets to the assigned slots. Herein, for example, a sensor node 3 having a high priority number and a sensor node 1 can transmit packets (1501 and 1502) to an emergency period (1504) of a slot 3 (SLT3) and an emergency period (1505) of a slot 4 (SLT4), respectively. Also in this case, influence is not exerted on a packet (1503) of a sensor node which is assigned to another normal period (1506).

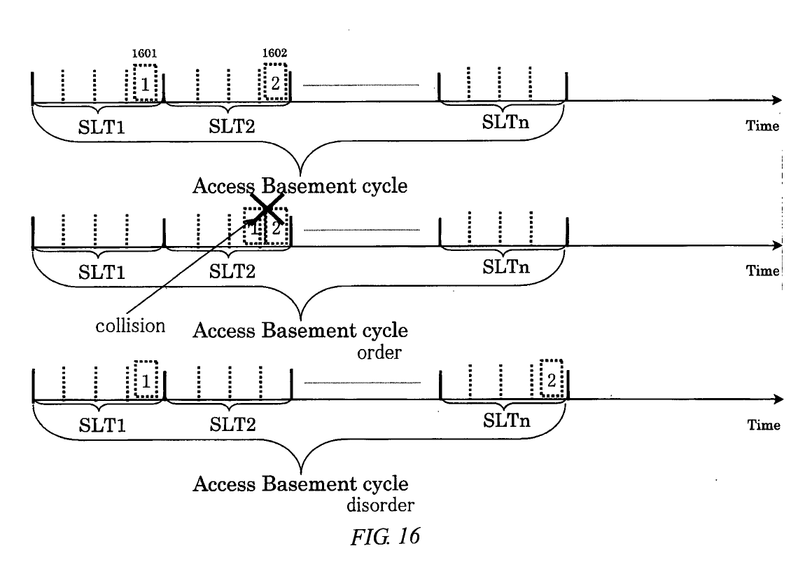

When the sensor nodes are regularly disposed, no interval is provided between another slot as shown in FIG. 16, and when the deviation among the RTCs of the sensor nodes is extremely large, a packet may collide with the packet of another sensor node.

However, when the regularity of assignment is taken away, the interval between other slots can be reserved more than when they are regularly disposed. In this case, the avoiding rate of packet collision due to the intervals between sensor nodes can be increased.

In the foregoing, the invention made by the inventors of the present invention has been concretely described based on the embodiments. However, it is needless to say that the present invention is not limited to the foregoing embodiments and various modifications and alterations can be made within the scope of the present invention.

What is claimed is:

1. A communication method of a TDMA method in which each of a plurality of sensor nodes including a first sensor node and a second sensor node communicates with a base station by use of each of a plurality of slots obtained by subjecting a predetermined period to time division; wherein
the plurality of slots includes a first slot and a second slot;
each of the plurality of slots is subjected to time division into a plurality of periods;
the plurality of periods has a first period and a second period;
in a first state, the first sensor node performs communication in the first period of the first slot, and the second sensor node performs communication in the first period of the second slot; and
in a second state, the first sensor node performs communication in the first period of the first slot, and the second sensor node performs communication in the second period of the first slot.

2. A communication method according to claim 1, wherein
each of the plurality of sensor nodes has a CPU for receiving a packet transmitted from the base station, and a RTC for outputting a signal for activating the CPU according to a parameter contained in the packet; and
when a time interval at which the CPU is activated is changed, a transition from the first state to the second state is made.

3. A communication method according to claim 2, wherein
each of the plurality of sensor nodes further has a sensor for outputting the information obtained by sensing to the CPU; and
when the information obtained by sensing exceeds a predetermined threshold value, the time interval at which the CPU is activated is changed.

4. A communication method according to claim 1, wherein
the plurality of periods further has a third period;
the base station transmits a packet to each of the third periods of the plurality of slots; and
each of the plurality of sensor nodes determines to communicate with the base station according to a parameter contained in the packet.

5. A communication method according to claim 4, wherein
each of the plurality of sensor nodes determines to communicate with the base station by comparing a number stored in the sensor node and the parameter.

6. A communication method according to claim 4, wherein
the plurality of periods further has a fourth period; and,
according to the packet transmitted from the base station, each of the plurality of sensor nodes communicates with the base station by use of each of the fourth periods of the plurality of slots.

7. A communication method according to claim 6, wherein
each of the plurality of sensor nodes communicates with the base station by use of each of the fourth periods, and then, performs communication by use of the first period.
